(19) United States
(12) Patent Application Publication
(10) Pub. No.: US 2018/0113234 A1
(43) Pub. Date: Apr. 26, 2018

(54) SYSTEM AND METHOD FOR OBSTACLE DETECTION

(71) Applicant: CAINIAO SMART LOGISTICS HOLDING LIMITED, GRAND CAYMAN (KY)

(72) Inventors: BO YE, HANGZHOU (CN); JUNBO CHEN, HANGZHOU (CN)

(21) Appl. No.: 15/789,797

(22) Filed: Oct. 20, 2017

(30) Foreign Application Priority Data
Oct. 25, 2016 (CN) 201610941455.2

(51) Int. Cl. G01V 8/10

(52) U.S. Cl. CPC G01V 8/10

(57) ABSTRACT

The present disclosure provides obstacle detection methods and systems. An example obstacle detection method comprises acquiring a first position, wherein the first position is a scanned position of a target object at a first moment, predicting a second position based on the first position, wherein the second position is a predicted position of the target object at a second moment, acquiring a third position, wherein the third position is a scanned position of the target object at the second moment, and matching the second position and the third position to obtain a matching result, and detecting one or more dynamic or static obstacles from the target object based on the matching result.

### CROSS REFERENCE TO RELATED APPLICATIONS

The present application is based on and claims priority to the Chinese Application No. 201610941455.2, filed Oct. 25, 2016, the entire contents of which are incorporated herein by reference.

### TECHNICAL FIELD

The present application relates to the computer field. In particular, it relates to systems and methods for obstacle detection.

### BACKGROUND

In technologies such as automatic navigation, it is often necessary to detect obstacles and determine whether they are dynamic obstacles or static. For example, robots need to detect dynamic obstacles during the automatic navigation process and calculate an appropriate navigation route based on a predicted rate of travel and trajectory of a dynamic obstacle to ensure safety during the automatic navigation.

In existing technologies, to determine whether an obstacle is dynamic or static, the model-based detection method can be used. This detection mode first requires the establishment of multiple statistical models, with each statistical model corresponding to a separate type of obstacle. For example, vehicles and pedestrians correspond to different statistical models. A camera is configured to film the image to be detected, and the type of obstacle in the image is analyzed; thus, a corresponding statistical model is selected to conduct obstacle detection.

However, building statistical models based on various obstacle types requires a large amount of data to conduct statistical model training, and features high computational complexity, thus leading to poor real-time performance.

### SUMMARY

In various embodiments, this disclosure provides obstacle detection methods and systems that do not requiring building statistical models based on obstacle type, thus reducing computational complexity and improving real-time performance.

According to one aspect, an obstacle detection method is disclosed, the method comprising: acquiring a first position, with the first position being the scanned position of the target object at the first moment; predicting a second position based on the first position, with the second position being the predicted position of the target object at the second moment; acquiring a third position, with the third position being the scanned position of the target object at the second moment; and conducting matching of the second position and third position, acquiring the matching results, and detecting obstacles including dynamic obstacles or static obstacles from the target objects based on the matching results.

In some embodiments, optionally, acquiring the first position comprises: acquiring the position of the target object's first scan point array at the first moment, and based on the first scan point array position, converting the first scan point array into a first line segment set, and letting the first line segment set position serve as the first position. Acquiring the third position comprises: acquiring the target object's second scan point array position at the second moment, and based on the second scan point array position, converting the second scan point array into a second line segment set, and letting the second line segment set position serve as the third position.

In some embodiments, optionally, converting the first scan point array into a first line segment set comprises: converting the first scan point array into a first line segment set based on a length threshold, wherein the distance between each scan point in the first scan point array and the converted line segment corresponding to each scan point is less than the length threshold. Converting the second scan point array into a second line segment set comprises: converting the second scan point array into a second line segment set based on a length threshold, wherein, the distance between each scan point in the second scan point array and the converted line segment corresponding to each scan point is less than the length threshold.

In some embodiments, optionally, prior to detecting obstacles including dynamic obstacles or static obstacles from the target objects, the method also comprises: deleting the first object from the target objects if the point density of the scan point array corresponding to the first line segment is less than a density threshold, the first line segment set comprising the first line segment corresponding to the first object; or deleting the first object from the target objects if the point density of the scan point array corresponding to the second line segment is less than a density threshold, the second line segment set comprising the second line segment corresponding to the first object.

In some embodiments, optionally, the first line segment set comprises the third line segment corresponding to the second object, the second line segment set comprises the fourth line segment corresponding to the second object, and prior to detecting obstacles including dynamic obstacles or static obstacles from the target objects, the method also comprises: acquiring the tilt angle of the third line segment and the tilt angle of the fourth line segment; deleting the second object from the target objects if the difference between the tilt angle of the third line segment and the tilt angle of the fourth line segment is greater than the angle threshold.

In some embodiments, optionally, detecting obstacles including dynamic obstacles or static obstacles from the target objects based on the matching results comprises: if the matching results indicate that the predicted position of the third object at the second moment matches the scanned position of the third object at the second moment, the third object is detected as a static obstacle; if the matching results indicate that the predicted position of the fourth object at the second moment matches the scanned position of the fourth object at the second moment, the fourth object is detected as a dynamic obstacle.

In some embodiments, the method is used in a movable device;

In some embodiments, predicting the second position based on the first position comprises: predicting a second position based on the first position and the path of movement of the movable device from the first moment to the second moment.

In some embodiments, optionally, after detecting obstacles including dynamic obstacles or static obstacles from the target objects, the method also comprises: acquiring a priori map information for the region of the target object's position, the a priori map information comprises background obstacle positions; and revising the detected dynamic obstacles or static obstacles based on the background obstacle positions.

In some embodiments, optionally, the method also comprises: generating a detection confidence level based on the matching results. Revising the detected dynamic obstacles or static obstacles based on the background obstacle positions comprises: revising the detected dynamic obstacles or static obstacles based on the background obstacle positions and detection confidence level.

In some embodiment, optionally, after detecting a dynamic obstacle from the target objects, the method also comprises: acquiring the rate of travel of the dynamic obstacle from the first moment to the second moment; and predicting the position of the dynamic obstacle at a third moment based on the scanned position of the dynamic obstacle at the first moment or second moment and the dynamic obstacle's rate of travel.

In some embodiments, optionally, the rate of travel of the dynamic obstacle from the first moment to the second moment is acquired, comprising: acquiring the dynamic obstacle's scan point array position at the first moment; acquiring the dynamic obstacle's corresponding linear slope and intercept at the first moment based on the dynamic obstacle's scan point array position at the first moment; acquiring the dynamic obstacle's scan point array position at the second moment; acquiring the dynamic obstacle's corresponding linear slope and intercept at the second moment based on the dynamic obstacle's scan point array position at the second moment; and acquiring the dynamic obstacle's rate of travel from the first moment to the second moment based on the dynamic obstacle's corresponding linear slope and intercept at the first moment and its linear slope and intercept corresponding to the second moment.

In some embodiments, optionally, the position of the dynamic obstacle at a third moment is predicted based on the scanned position of the dynamic obstacle at the first moment or second moment and the dynamic obstacle's rate of travel, comprising: acquiring the dynamic obstacle's displacement per unit of time based on the dynamic obstacle's rate of travel; and predicting the dynamic obstacle's position after at least one unit of time based on the dynamic obstacle's first moment or second moment scanned position and the dynamic obstacle's displacement per unit of time.

In some embodiments, optionally, the first position is acquired, comprising: conducting laser scanning of the target object at the first moment and acquiring the first position; and acquiring the third position, comprising: conducting laser scanning of the target object at the second moment and acquiring the third position.

According to another aspect, an obstacle detection device comprises: a first acquisition unit, configured to acquire a first position; the first position is the scanned position of the target object at the first moment; a prediction unit, configured to predict a second position based on the first position, the second position is the predicted position of the target object at the second moment; a second acquisition unit, configured to acquire a third position; the third position is the scanned position of the target object at the second moment; and a detection unit, configured to conduct matching of the second position and the third position, acquire matching results, and detect obstacles including dynamic obstacles or static obstacles from the target objects based on the matching results.

In some embodiments, optionally, the first acquisition unit is configured to acquire the position of the target object's first scan point array at the first moment, and based on the first scan point array position, convert the first scan point array into a first line segment set, and let the first line segment set position serve as the first position. The second acquisition unit is configured to acquire the target object's second scan point array position at the second moment, and based on the second scan point array position, convert the second scan point array into a second line segment set, and let the second line segment set position serve as the third position.

In some embodiments, optionally, when converting the first scan point array into a first line segment set, the first acquisition unit is configured to: convert the first scan point array into a first line segment set based on a length threshold, wherein, the distance between each scan point in the first scan point array and the converted line segment corresponding to each scan point is less than the length threshold. When converting the second scan point array into a second line segment set, the second acquisition unit is configured to: convert the second scan point array into a second line segment set based on a length threshold, wherein, the distance between each scan point in the second scan point array and the converted line segment corresponding to each scan point is less than the length threshold.

In some embodiments, optionally, the device also comprises: a first deleting unit, used in the detection unit prior to detecting obstacles including dynamic obstacles or static obstacles from the target objects, to delete the first object from the target objects if the point density of the scan point array corresponding to the first line segment is less than a density threshold, with the first line segment set including the first line segment corresponding to the first object; or deleting the first object from the target objects if the point density of the scan point array corresponding to the second line segment is less than a density threshold, with the second line segment set including the second line segment corresponding to the first object.

In some embodiments, optionally, the first line segment set comprises the third line segment corresponding to the second object, the second line segment set comprises the fourth line segment corresponding to the second object, and the device also comprises: a second deleting unit, used in the detection unit prior to detecting obstacles including dynamic obstacles or static obstacles from the target objects, to acquire the tilt angle of the third line segment and the tilt angle of the fourth line segment; and delete the second object from the target objects if the difference between the tilt angle of the third line segment and the tilt angle of the fourth line segment is greater than the angle threshold.

In some embodiments, optionally, when dynamic obstacles or static obstacles are detected from the target objects based on the matching results, the detection unit configured to: detect the third object as a static obstacle if the matching results indicate that the predicted position of the third object at the second moment matches the scanned position of the third object at the second moment; or detect the fourth object as a dynamic obstacle if the matching results indicate that the predicted position of the fourth object at the second moment matches the scanned position of the fourth object at the second moment.

In some embodiments, optionally, the device also comprises: a revision unit, configured to acquire a priori map information for the region of the target object's position, with the a priori map information comprising background obstacle positions; and revise the detected dynamic obstacles or static obstacles based on the background obstacle positions.

In some embodiments, optionally, it also comprises: a prediction unit, used after the detection unit detects a dynamic obstacle from the target objects, to acquire the rate of travel of the dynamic obstacle from the first moment to the second moment; and predict the position of the dynamic obstacle at a third moment based on the scanned position of the dynamic obstacle at the first moment or second moment and the dynamic obstacle's rate of travel.

In some embodiments, optionally, the first acquisition unit is configured to conduct laser scanning of the target object at the first moment and acquire the first position; the second acquisition unit is configured to conduct laser scanning of the target object at the second moment and acquire the third position.

According to another aspect, anon-transitory computer-readable storage medium storing instructions that, when executed by a system, cause the system to perform a method for obstable detection. The method comprises: acquiring a first position, wherein the first position is a scanned position of a target object at a first moment; predicting a second position based on the first position, wherein the second position is a predicted position of the target object at a second moment; acquiring a third position, wherein the third position is a scanned position of the target object at the second moment; and matching the second position and the third position to obtain a matching result, and detecting one or more dynamic or static obstacles from the target object based on the matching result.

According to another aspect, a transport vehicle comprises: a scanning device, configured to conduct scanning of the target object at the first moment and acquire a first position, and to conduct scanning of the target object at the second moment and acquire a third position; the first position is the scanned position of the target object at the first moment, and the third position is the scanned position of the target object at the second moment; and a processor, configured to predict a second position based on the first position, with the second position being the predicted position of the target object at the second moment; and to conduct matching of the second position and the third position, acquire matching results, and detect obstacles including dynamic obstacles or static obstacles from the target objects based on the matching results.

In various embodiments, the scanned position of the target object at the first moment is acquired, i.e., the first position, and the position of the target object at the second moment is acquired, i.e., the third position; based on the first position, the position of the target object at the second moment is predicted, i.e., the second position. Matching results are acquired by conducting matching of the second position and third position, and dynamic obstacles or static obstacles are detected from the target objects based on the matching results. The obstacle detection method provided by the embodiments of the present application may not require reliance on statistical models and can detect obstacles in real-time, thus reducing computational complexity and improving real-time performance.

### BRIEF DESCRIPTION OF THE DRAWINGS

The attached drawings of the description below are mere embodiments of the present application. Those possessing ordinary skill in the art could obtain other drawings based upon these attached drawings.

FIG. 1 is a flowchart of a method embodiment of an obstacle detection method consistent with the present disclosure.

FIG. 2 is a diagram of an acquired scan point array consistent with the present disclosure.

FIG. 3 is a diagram of a target object's scanned position consistent with the present disclosure.

FIG. 4 is a diagram of a target object's line segment set consistent with the present disclosure.

FIG. 5 is a flowchart of an example method for converting a scan point array into a line segment set consistent with the present disclosure.

FIGS. 6a, 6b, 6c, and 6d are diagrams of the conversion of scan point arrays into line segments consistent with the present disclosure.

FIG. 7 is a diagram of object deletion based on point density consistent with the present disclosure.

FIG. 8 is a schematic structural diagram of an example device of the obstacle detection device consistent with the present disclosure.

FIG. 9 is a schematic structural diagram of an example device of the transport vehicle consistent with the present disclosure.

### DETAILED DESCRIPTION

The embodiments described herein are merely exemplary and are not all of the embodiments. All other embodiments acquired by those possessing ordinary skill in the art, without creative efforts and based on the embodiments of the present disclosure, shall fall within the scope of protection.

In current technologies such as automatic navigation, to detect obstacles and determine whether they are dynamic obstacles or static, the model-based detection method can be used. This detection mode requires the establishment of multiple statistical models, with each statistical model corresponding to a separate type of obstacle. For example, vehicles and pedestrians correspond to different statistical models. A camera is configured to film the image to be detected, and the image in the film is analyzed based on image recognition methods. Thus, relevant information, such as the shape of the obstacle, is acquired, and the obstacle type is determined based on this information. Further, a corresponding statistical model can be selected to conduct obstacle detection.

Because this detection mode requires the establishment of statistical models based on obstacle type, in addition to requiring a large amount of data to conduct statistical model training, every new type of obstacle requires a new statistical model, causing high computational complexity and poor real-time performance. In addition, filming with a camera often causes problems such as a limited field of view and vulnerability to the effects of lighting during filming, leading to poor detection accuracy. Also, image analysis requires significant calculation power, further lowering real-time performance.

The obstacle detection methods and systems provided by the present disclosure's embodiments can reduce computational complexity and improving real-time performance. In addition, filming with a camera is obviated, eliminating the problems of a limited field of view and vulnerability to the effects of lighting during filming, further improving accuracy and real-time performance.

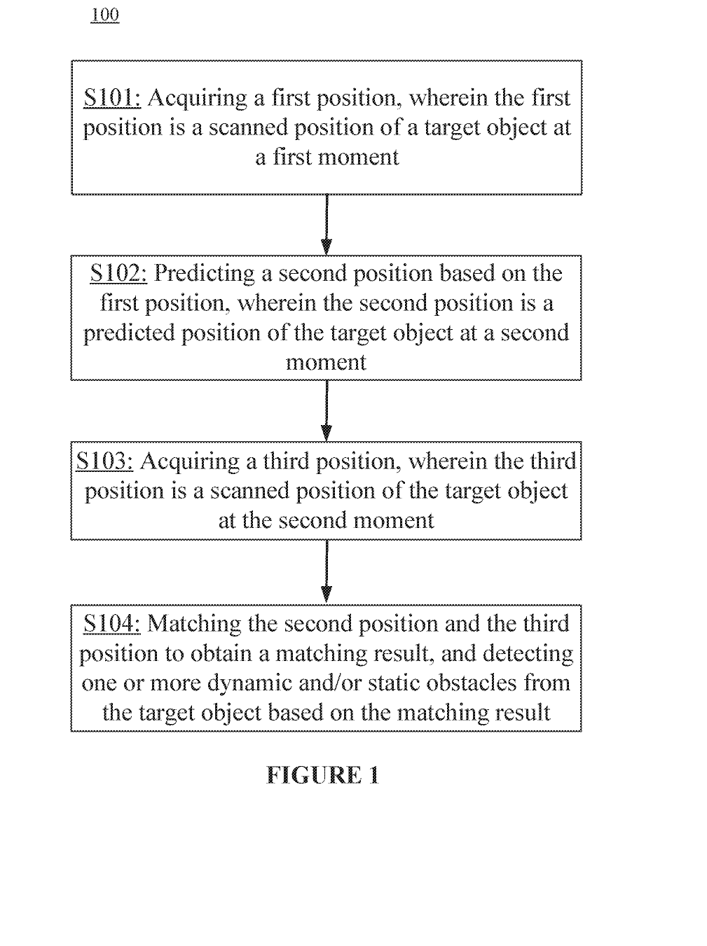

An example obstacle detection method 100 is shown in FIG. 1.

The embodiments of the present application can be implemented on obstacle detection devices, wherein the detection device can be a fixed-position device, such as a monitor fixed at a certain location; or it can be a movable device itself or mounted on a movable device. For example, the detection device can be a movable device such as a transport vehicle, or can be mounted on a movable device. Here, the transport vehicles include wheelchairs, hoverboards, robots, etc.

The method 100 of the present embodiment comprises the following steps.

S101 includes acquiring a first position, wherein the first position is a scanned position of a target object at a first moment. The target object may comprise one or more objects (e.g., a first object, a second object, a third object, a fourth object, etc. as described below).

In some embodiments, the first position can be acquired through scanning, e.g., optical scanning (hereinafter referred to as laser scanning) based on LIDAR (light detection and ranging), position-depth detector, etc. For example, acquiring the first position comprises: conducting laser scanning of the target object at the first moment and acquiring the first position. When laser scanning is deployed, the scanning range is broad and can cover a great distance, e.g., the scanning angle can reach 270 degrees and the scanning distance can reach 50 meters. Also, the laser scanning is highly adaptive to the environment and is not sensitive to lighting changes, thus can improve detection accuracy.

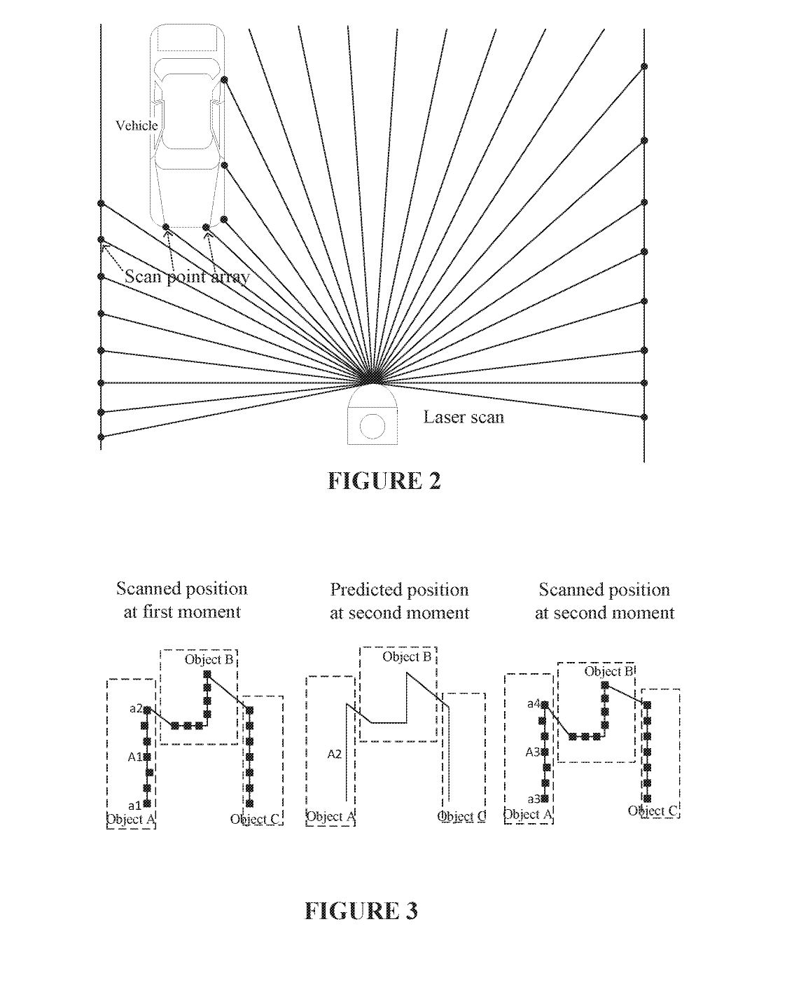

In some embodiments, following the scanning of the target object, a scan point array for the target object can be acquired. As shown in FIG. 2, after the detection device conducts laser scanning, a scan point array for the vehicle and other obstacles (if present) can be acquired. Here, the scan point array comprises at least two scan points, and a scan point is the contact point between the scanning medium, such as the laser beam, and the obstacle. Therefore, the scanned position of the target object's boundary contour can be obtained from this step. In one embodiment, it is possible to use the position of the acquired scan point array as the position of the target object, and the scan point array can be converted into a line segment set, using the position of this line segment set as the position of the target object.

S102 includes predicting a second position based on the first position, wherein the second position is a predicted position of the target object at a second moment.

In some embodiments, when predicting the second position based on the first position, the target object can be assumed to be a static object, e.g., assuming that the target object does not move from the first moment to the second moment. Therefore, if the position of the detection device is fixed, the first position acquired in S101 can be used as the predicted position of the target object at the second moment. If the detection device is a movable device or is mounted on a movable device, the second position can be predicted based on the first position and a movement path of the movable device from the first moment to the second moment.

S103 includes acquiring a third position, wherein the third position is a scanned position of the target object at the second moment.

The process of acquiring a third position in this step is similar to the process of acquiring the first position S101, which will not be reiterated here.

The second moment can be later than the first moment, and it can also be earlier than the first moment. For example, moment t1<moment t2. The disclosed embodiments can predict the scanned position at moment t2 based on the scanned position of the target object at moment t1, and can also predict the scanned position at moment t1 based on the scanned position of the target object at moment t2.

S104 includes matching the second position and the third position to obtain a matching result, and detecting one or more dynamic or static obstacles from the target object based on the matching result.

In some embodiments, according to S102, the second position is the predicted position of the target object at the second moment, and according to S103, the third position is the scanned position of the target object at the second moment. Therefore, the matching result for the second position and third position can indicate whether the target object's scanned position and predicted position at the second moment match each other. Since the prediction assumes that the target object does not move, it is possible to detect whether the target object moves based on the matching result for the scanned position and predicted position, that is, whether the target object comprises dynamic obstacles or static obstacles.

For example, the target object includes a third object and fourth object. If the matching result indicates that the predicted position of the third object at the second moment matches the scanned position of the third object at the second moment, the third object did not move from the first moment to the second moment. Therefore, the third object can be determined to be a static obstacle. If the matching result indicates that the predicted position of the fourth object at the second moment does not match the scanned position of the fourth object at the second moment, the fourth object moved from the first moment to the second moment. Therefore, the fourth object can be determined to be a dynamic obstacle. An additional example is given below.

As shown in FIG. 3, the target object contains Object A, Object B, and Object C. Here, the position of line segment A1 (the line segment comprising scan points from a1 to a2) is the scanned position of Object A at the first moment. Based on the position of line segment A1, it is possible to predict the predicted position of Object A at the second moment, i.e., to predict the position of line segment A2. The position of line segment A3 (the line segment comprising scan points a3 to a4) is the scanned position of Object A at the second moment. If the matching results indicate that the scanned position and predicted position of Object A at the second moment substantially overlap, this indicates that Object A did not move from the first moment to the second moment. Therefore, Object A can be determined to be a static obstacle. Similarly, if the matching results indicate that there is a large difference between the scanned position and predicted position of Object B at the second moment, and the scanned position and predicted position of Object C at the second moment substantially overlap, Object B can be determined to be a dynamic obstacle, and Object C can be determined to be a static obstacle.

In some embodiments, “static” and “dynamic” refer to states during a period of time from the first moment to the second moment. For example, a detected static obstacle could have been determined to be dynamic in a previous detection process. Therefore, the embodiments of the present application can also determine whether the static obstacle detected in S104 is potentially a dynamic obstacle based on one or more detection results prior to the first moment and second moment.

In some embodiments, the scanned position of the target object at the first moment, i.e., the first position, is acquired; the scanned position of the target object at the second moment, i.e., the third position, is acquired; and based on the first position, the position of the target object at the second moment, i.e., the second position, is predicted. A matching result can be acquired by matching the second position and third position, and one or more dynamic obstacles or static obstacles can be detected from the target object based on the matching result. The obstacle detection method obviates the reliance of statistical models, thus reducing computational complexity and improving real-time performance.

In some embodiments, scanning can be conducted by various scanning devices such as lasers, cameras, etc. The scanning range is quite broad and covers a large distance. The scanning is highly adaptive to the environment and is not sensitive to lighting changes, further improving detection accuracy. Also, because image analysis is not necessary, real-time performance can be improved.

In some embodiments, after conducting scanning of the target object using a scanning device such as a laser, it is possible to acquire a scan point array. To reduce computational complexity, matching can be conducted after conducting point to line conversion.

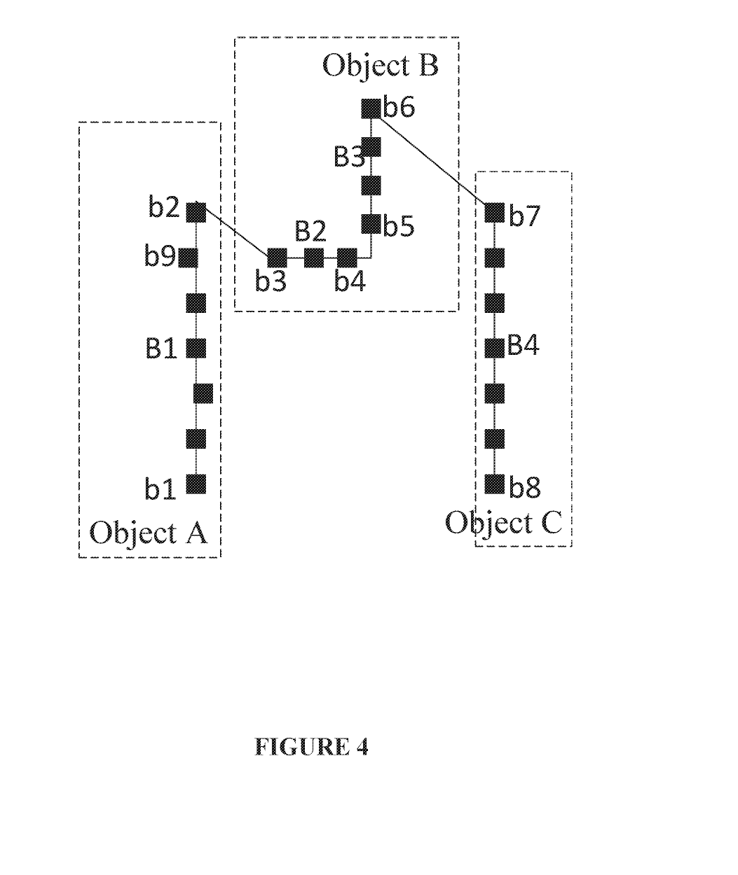

For example, the Step S101 comprises: acquiring the position of the target object's first scan point array at the first moment, and converting the first scan point array into a first line segment set based on the first scan point array's position, the first line segment set's position indicating the first position. As shown in FIG. 4, Object A, Object B, and Object C are scanned at the first moment, and the position of the first scan point array is acquired, wherein the first scan point array comprises the 21 scan points (black squares shown in FIG. 4). The first scan point array is converted into a first line segment set comprising line segment B1, line segment B2, line segment B3, and line segment B4. The position of the first line segment set is the first position.

Furthermore, Step S103 comprises: acquiring the target object's second scan point array position at the second moment, and converting the second scan point array into a second line segment set based on the second scan point array position, the second line segment set's position indicating the third position.

The process of converting a scan point array into a line segment set is discussed below.

There can be multiple ways to convert scan points into a line segment set, such as converting two adjacent scan points into one line segment. However, given that a scan point array could contain a large number of scan points, if all adjacent scan points are connected and converted into line segments, there would be a large number of line segments, leading to considerable computational complexity in the matching step. Therefore, in some embodiments, it is possible to set a length threshold, converting scan points substantially in the same straight line into one line segment. Thus, with a minimum effect to the accuracy, the number of line segments is reduced, further improving real-time performance.

For example, converting the first scan point array into the first line segment set comprises: converting the first scan point array into the first line segment set based on a length threshold (the first line segment comprising one or more converted first line segments, each first line segments corresponding to one or more first scan points), wherein a distance between each scan point in the first scan point array and the corresponding converted line segment is less than the length threshold. For example, as shown in FIG. 4, the first line segment set converted from the first scan point array comprises: line segment B1, line segment B2, line segment B3, and line segment B4. Here, scan point b9 of the first scan point array can be converted into line segment B1, where the distance between scan point b9 and line segment B1 is less than the length threshold. Converting the second scan point array into the second line segment set comprises: converting the second scan point array into the second line segment set based on the length threshold, where the distance between each scan point in the second scan point array and the corresponding converted line segment is less than the length threshold.

An example of the foregoing conversion method is discussed below.

As shown in FIG. 5, the foregoing conversion method can comprise the following steps.

S501 includes connecting the beginning scan point and end scan point of the scan point array into a current line segment. The scan points in the scan point array aside from the beginning scan point and the end scan point are used as remainder scan points.

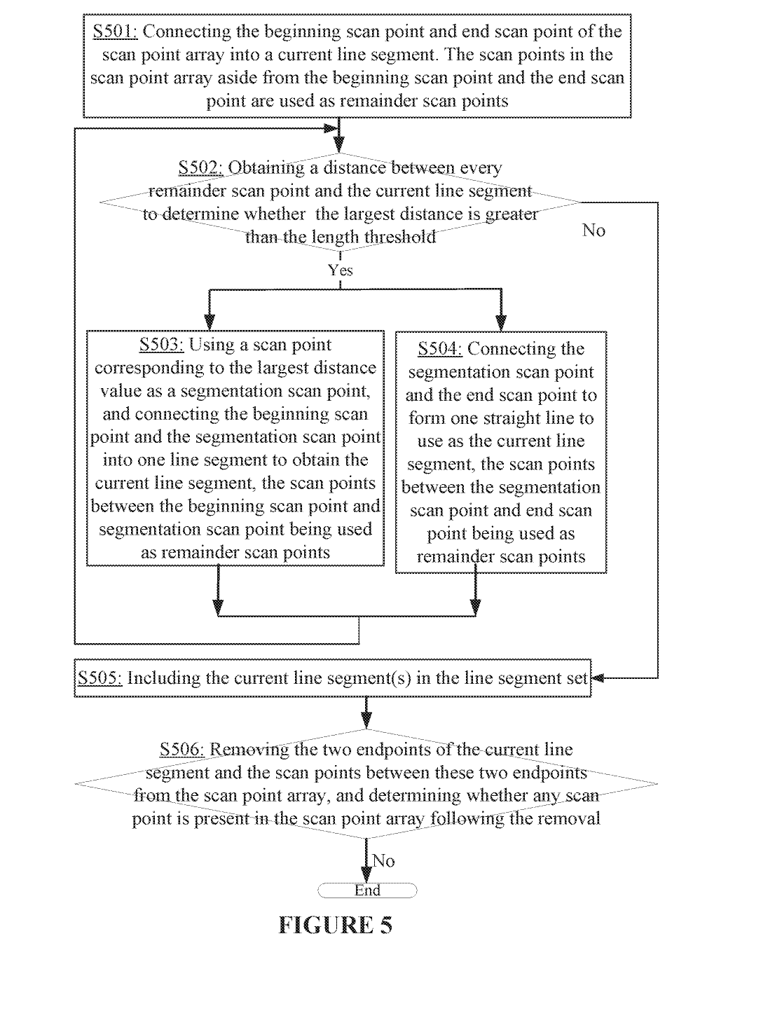

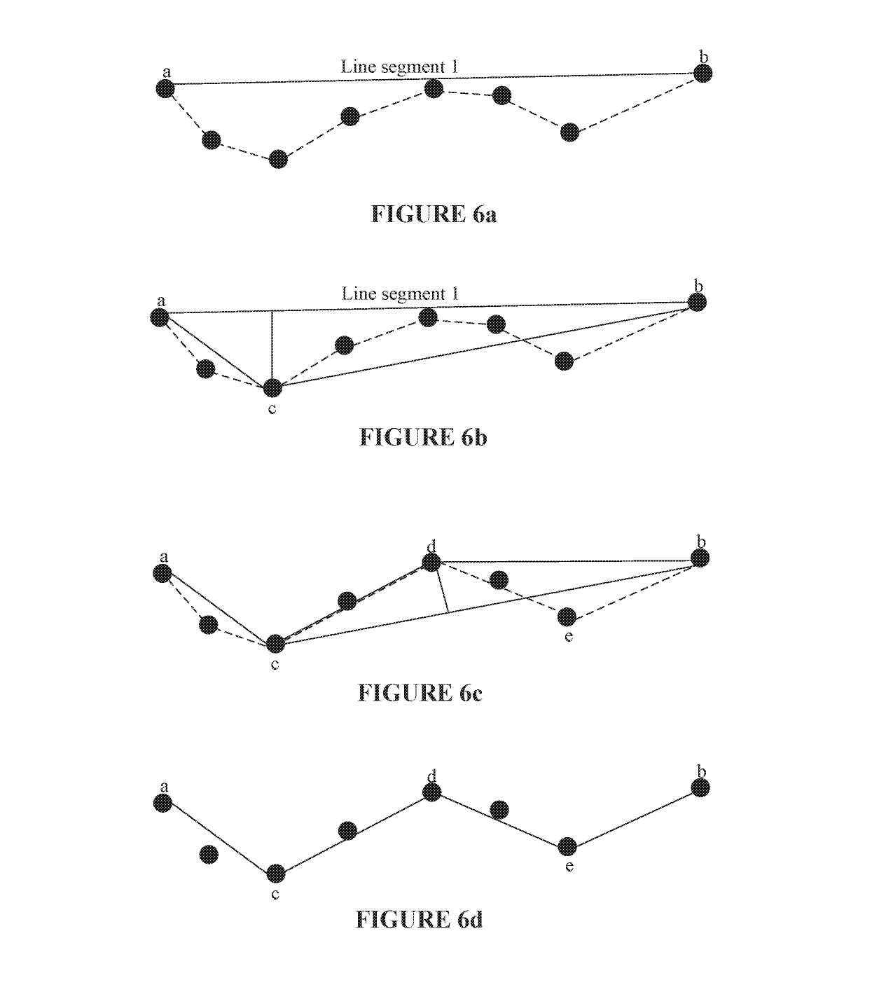

Here, the beginning scan point is the scan point first obtained by the scanning process, and the end scan point is the scan point last obtained by the scanning process. For example, as shown in FIG. 6a, scan point a is the beginning scan point, scan point b is the end scan point, and scan point a and scan point b are connected to form line segment 1. Furthermore, line segment 1 can be used as the current line segment, and the scan points aside from scan point a and scan point b are remainder scan points.

S502 includes obtaining a distance between every remainder scan point and the current line segment to determine whether the largest distance is greater than the length threshold.

If the largest distance is less than the length threshold, it indicates that all of the distances from the remainder scan points to the current line segment are small. Thus, every remainder scan point is approximately on the current line segment, and the current line segment is included in the line segment set. Accordingly, S505 is executed (FIG. 5). As shown in FIG. 6b, of all the remainder scan points, the distance between scan point c and line segment 1 is the greatest. If this distance is less than length threshold Th, line segment 1 is included in the line segment set.

If the distance between a remainder scan point and the current line segment is greater than the threshold, it indicates that not every remainder scan point is approximately on the current line segment, so S503 and S504 are executed (FIG. 5). As shown in FIG. 6b, the distance from scan point c to line segment 1 is greater than length threshold Th, so S503 and S504 are executed.

S503 includes using a scan point corresponding to the largest distance value as a segmentation scan point, and connecting the beginning scan point and the segmentation scan point into one line segment to obtain the current line segment. The scan points between the beginning scan point and segmentation scan point are used as remainder scan points, and the method returns to Step S502 (FIG. 5).

As shown in FIG. 6c, scan point a and scan point c are connected to form one line segment, and by returning to Step S502, the line segment formed by connecting scan point a and scan point c is included in the line segment set. It is not necessary to conduct further segmentation of this line segment.

S504 includes connecting the segmentation scan point and the end scan point to form one straight line to use as the current line segment; the scan points between the segmentation scan point and end scan point are used as remainder scan points, and the process returns to the execution of Step S502.

As shown in FIG. 6c, scan point c and scan point b are connected to form one line segment, and by returning to Step S502, further segmentation of this line segment can be conducted similar to the FIG. 6a and FIG. 6b. Finally, a line segment formed by connecting scan point c and scan point d, a line segment formed by connecting scan point d and scan point e, and a line segment formed by connecting scan point e and scan point b are included in the line segment set.

It should be noted that the execution sequence of S503 and S504 is not limited to the above. It is possible to first execute S503 then S504, it is possible to first execute S504 then S503, and it is also possible to simultaneously execute S503 and S504.

S505 includes including the current line segment(s) in the line segment set.

S506 includes removing the two endpoints of the current line segment and the scan points between these two endpoints from the scan point array, and determining whether any scan point is present in the scan point array following the removal. If there is none, it indicates that the point to line conversion has been completed, so the method is concluded, i.e., the final line segment set has been obtained. If there is, it indicates that this method has not ended.

For example, the final line segment set is shown in FIG. 6d, wherein the distance of every scan point from the line segment converted from these scan points is less than the length threshold.

It is clear that the conversion method described above conducts point to line cluster conversion through an iteration approach, reducing the number of line segments, and thus improving real-time performance and accuracy.

In some embodiments, the foregoing process of converting scan point arrays into line segment sets may connect the scan points of different obstacles to each other, resulting in an erroneous connection of obstacles. As shown in FIG. 4, scan point b2 and scan point b3 are the scan points of different obstacles. When conducting line segment conversion, these two points could be connected to form a line segment, but this line segment is not a line segment corresponding to an obstacle.

With regard to line segments erroneously connecting obstacles, since scan points are usually generated according to a fixed time interval during scanning, the scan points possess a certain density. The scan point density of a line segment erroneously connecting obstacles would be lower than that of a line segment correctly connecting obstacles. Therefore, by judging the point densities of the scan point arrays, it is possible to remove line segments erroneously connecting obstacles.

For example, the first line segment set comprises a first line segment corresponding to a first object, and the first object is removed from the target objects if a point density of a scan point array corresponding to the first line segment is less than a density threshold; that is, the obstacle type of the first object is not identified, which is equivalent to determining that the first object is a non-obstacle. Or the second line segment set comprises a second line segment corresponding to the first object, and the second object is removed from the target objects if a point density of a scan point array corresponding to the second line segment is less than the density threshold. Here, the density threshold can be set based on the scan time interval in a scanning cycle.

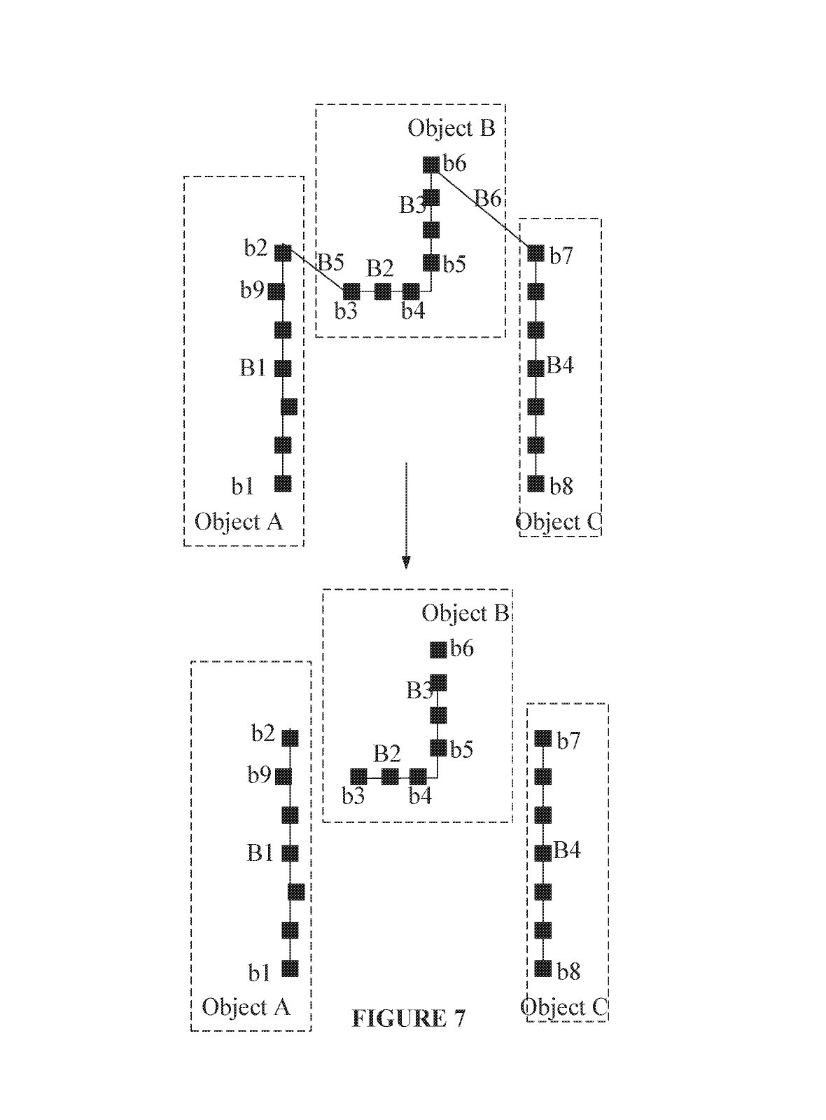

In one example, the top illustration of FIG. 7 is the line segment set corresponding to the target object, and it comprises line segments B1-B6. Based on the point densities of the scan point arrays corresponding to the line segments, it is possible to determine that the point densities of line segment B5 and line segment B6 are less than the density threshold, which means that line segment B5 and line segment B6 are lines erroneously connecting obstacles. The object corresponding to line segment B5 and the object corresponding to line segment B6 can be removed from the target objects, i.e., it is determined that obstacles are not present at the positions corresponding to line segment B5 and line segment B6. Thus, line segment set shown at the bottom of FIG. 7 is obtained, comprising line segments B1-B4.

By determining the point density of scan point arrays as described above, the objects corresponding to erroneous connecting lines between obstacles are removed, enhancing detection accuracy, reducing the workload of the detection device when conducting matching, and further improving detection efficiency.

In some embodiments, such as when the speed of the detection device or target object is too fast, or when the appearance of new obstacles leads to overlapping obstacles, the obstacle type may not be determined, i.e., it is not possible to detect whether an obstacle present from the target objects is static or dynamic.

For the situation described above in which detection is not possible, a determination can be made based on the difference in line segment tilt angles. When the difference in line segment tilt angles is very large, it means that there is a static obstacle or dynamic obstacle from the target objects that the detection device is unable to detect. For example, the first line segment set comprises a third line segment corresponding to a second object, and the second line segment set comprises a fourth line segment corresponding to the second object. Prior to detecting obstacles including dynamic obstacles or static obstacles from the target objects, the method also comprises: acquiring the tilt angle of the third line segment and the tilt angle of the fourth line segment, and removing the second object from the target objects if the difference between the tilt angle of the third line segment and the tilt angle of the fourth line segment is greater than the angle threshold. Thus, no determination is made on whether the second object is a static obstacle or dynamic obstacle. The second object's obstacle type can be determined at the next moment.

To further improve the accuracy of the detection results, the detection results can be revised based on an a priori map in some embodiments. Here, the a priori map is a map comprising the background obstacles of a region in which the target objects are located.

For example, a priori map information for the region of the target object's position is acquired, and the a priori map information comprises background obstacle positions; the detected dynamic obstacles or static obstacles are revised based on the background obstacle positions. Here, background obstacles can be static obstacles in the region in which the target objects are located.

For example, when the detection device detects the position of a static obstacle, and there are no obstacles in the a priori map, it means that the detection results could be mistaken. At this time, the detection results can be revised as “no obstacles.” When the detection device detects the position of a dynamic obstacle, and there are no obstacles or there are static obstacles in the a priori map, it means that the detection results could be mistaken. At this time, the detection results can be revised as “no obstacles” or “static obstacles.”

If the selected reference points of the a priori map and detection device are different, the corresponding coordinate origins of the a priori map coordinate system and detection device coordinate system would be different. Therefore, prior to making revisions, it is necessary to unify the coordinate systems. For example, background obstacle positions can be down-converted from the a priori map coordinate system to the detection device coordinate system; or the positions of detected dynamic obstacles or static obstacles can be converted from the detection device coordinate system to the a priori map coordinate system.

Background obstacles could change with respect to the a priori map when the detection device conducts obstacle detection. For example, when the a priori map is acquired, there could be a vehicle parked in the corresponding region of the map. During obstacle detection, it could be that this vehicle is no longer located in the corresponding region, but the a priori map would mistakenly identify the vehicle as a static obstacle. When relying upon an a priori map to revise detection results, the presence of mistakes in the a priori map could lead to revision errors.

For situations in which there are mistakes in the a priori map, determination of a detection results confidence level can be added when the a priori map is relied upon to revise detection results. For example, a detection confidence level is generated based on the matching results, and the detected dynamic obstacles or static obstacles are revised based on the background obstacle positions, comprising: revising the detected dynamic obstacles or static obstacles based on the background obstacle positions and detection confidence level.

Here, it is possible to obtain a detection confidence level using the corresponding matching degree of the matching results. Stronger matches correspond to higher detection confidence level, indicating that the acquired detection results are more reliable. For example, when the a priori map does not conform to the detection results, if the detection confidence level of the detection results is high, revisions may not be made; if the detection confidence level of the detection results is low, revisions may be made based on the a priori map.

When the detected target objects include a dynamic obstacle, the trajectory of the dynamic obstacle can be further predicted. For example, the method also comprises: acquiring the rate of travel of the dynamic obstacle from the first moment to the second moment, and predicting the position of the dynamic obstacle at a third moment based on the scanned position of the dynamic obstacle at the first moment or second moment and the dynamic obstacle's rate of travel.

Here, when the rate of travel of the dynamic obstacle is acquired, the positions of the dynamic obstacle at the first moment and at the second moment can be acquired. The rate of travel is calculated based on the distance difference between these two positions, and on the time difference between the first moment and second moment.

In an alternative embodiment, the position of the dynamic obstacle can be indicated by a slope and an intercept of the line segment corresponding to the dynamic obstacle zone.

For example, the first scan point array and second scan point array have been converted into a first line segment set and second line segment set, respectively. The position of the dynamic obstacle at the first moment can be indicated by the slope and intercept of every line segment in the first line segment set, and the position of the dynamic obstacle at the second moment can be indicated by the slope and intercept of every line segment in the second line segment set. However, FIG. 6d shows that not every scan point is located on a corresponding line segment. Therefore, the position of the dynamic obstacle can be more accurately indicated through linear regression.

For example, the dynamic obstacle's scan point array position at the first moment is acquired; the dynamic obstacle's corresponding linear slope and intercept at the first moment are acquired based on the dynamic obstacle's scan point array position at the first moment; the dynamic obstacle's scan point array position at the second moment is acquired; the dynamic obstacle's corresponding linear slope and intercept at the second moment are acquired based on the dynamic obstacle's scan point array position at the second moment. After acquiring the obstacle's corresponding linear slope and intercept at the first moment as well as the corresponding linear slope and intercept at the second moment, which is equivalent to acquiring the position of the dynamic obstacle at the first moment and second moment, it is possible to acquire the dynamic obstacle's rate of travel from the first moment to the second moment.

Here, the dynamic obstacle's corresponding linear slope m at the first moment is:

m=S_{xy}/Sₓ

Here,

$${S}_{x} = n {\sum }_{i = 1}^{n} {x}_{i}^{2} - {( {\sum }_{i = 1}^{n} {x}_{i} )}^{2} , {S}_{xy} = n {\sum }_{i = 1}^{n} {x}_{i} {y}_{i} - {\sum }_{i = 1}^{n} {x}_{i} {\sum }_{i = 1}^{n} {y}_{i} ,$$

xᵢ and yᵢ are the horizontal and vertical coordinates of every scan point in the first scan point array, respectively, and n is the number of scan points of every line segment.

The dynamic obstacle's corresponding straight line intercept b at the first moment is:

$$b = ( {\sum }_{i = 1}^{n} {y}_{i} - m {\sum }_{i = 1}^{n} {x}_{i} ) / n$$

By replacing xᵢ and yᵢ in the above formula with the horizontal and vertical coordinates of every scan point in the second scan point array, it is possible to calculate the dynamic obstacle's corresponding linear slope and intercept at the first moment in the same way.

After calculating the rate of travel of the dynamic obstacle zone, it is then possible to predict the position of the dynamic obstacle. An example prediction method is described below.

First, based on the calculated rate of travel of the dynamic obstacle, the dynamic obstacle's displacement per unit of time is acquired, then the dynamic obstacle's position after at least one unit of time is predicted based on the dynamic obstacle's first moment or second moment scanned position and the dynamic obstacle's displacement per unit of time. As an example, the unit of time is 0.1 second, the displacement of the dynamic obstacle at 0.1 second is acquired, and displacement over j units of time is integrated. The predicted positions of the obstacle after k 0.1 seconds are acquired, wherein k=1, 2, . . . j. As k increases, the set covariance increases, indicating that the accuracy of the predicted positions grows lower.

Corresponding to the method embodiment described above, the present application also provides a corresponding device embodiment.

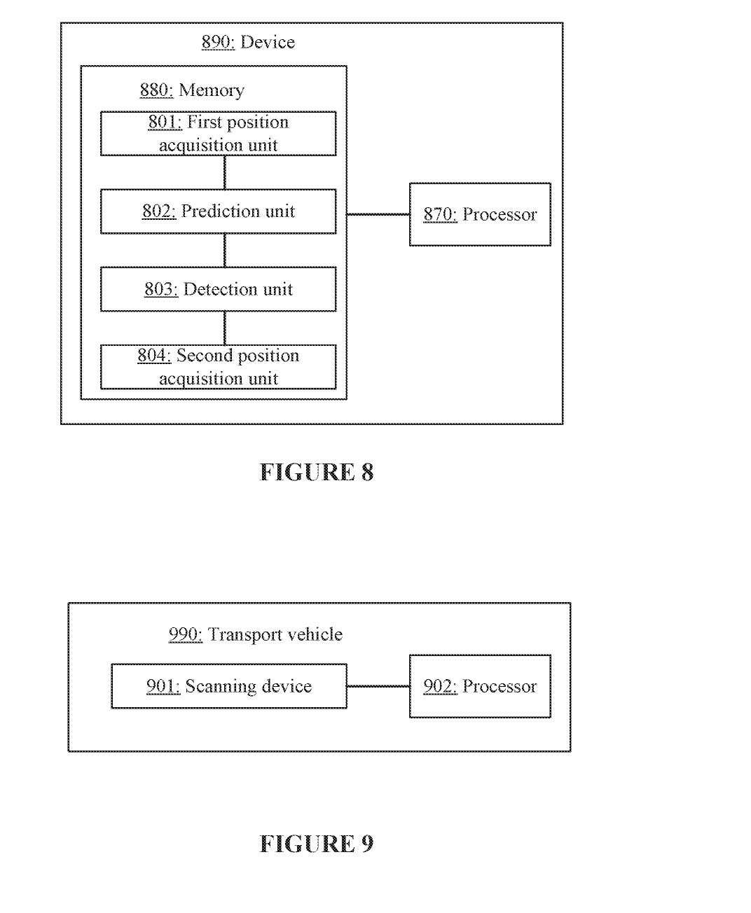

FIG. 8 illustrate an example obstacle detection device 890 consistent with the embodiments of the present disclosure. The device 890 may comprise a non-transitory computer-readable memory 880 and a processor 870. The memory 880 may store instructions (e.g., corresponding to various units described below) that, when executed by the processor 870, cause the device 890 to perform various steps and methods described herein. The instructions that are stored in memory 880 may comprise: a first acquisition unit 801, configured to acquire a first position; the first position is the scanned position of the target object at the first moment; a prediction unit 802, configured to predict a second position based on the first position; the second position is the predicted position of the target object at the second moment; a second acquisition unit 803, configured to acquire a third position; the third position is the scanned position of the target object at the second moment; and a detection unit 804, configured to conduct matching of the second position and the third position, acquire matching results, and detect dynamic obstacles or static obstacles from the target objects based on the matching results.

Optionally, the first acquisition unit is configured to acquire the position of the target object's first scan point array at the first moment, and based on the first scan point array position, convert the first scan point array into a first line segment set, and let the first line segment set position serve as the first position;

The second acquisition unit is configured to acquire the target object's second scan point array position at the second moment, and based on the second scan point array position, convert the second scan point array into a second line segment set, and let the second line segment set position serve as the third position.

Optionally, when converting the first scan point array into a first line segment set, the first acquisition unit is configured to: convert the first scan point array into a first line segment set based on a length threshold, wherein the distance between each scan point in the first scan point array and the converted line segment corresponding to each scan point is less than the length threshold. When converting the second scan point array into a second line segment set, the second acquisition unit is configured to: convert the second scan point array into a second line segment set based on a length threshold, wherein the distance between each scan point in the second scan point array and the converted line segment corresponding to each scan point is less than the length threshold.

Optionally, the instructions that are stored in memory 880 also comprise: a first deleting unit, used in the detection unit prior to detecting obstacles including dynamic obstacles or static obstacles from the target objects, to delete the first object from the target objects if the point density of the scan point array corresponding to the first line segment is less than a density threshold, with the first line segment set including the first line segment corresponding to the first object; or deleting the first object from the target objects if the point density of the scan point array corresponding to the second line segment is less than a density threshold, with the second line segment set including the second line segment corresponding to the first object.

Optionally, the first line segment set comprises the third line segment corresponding to the second object, the second line segment set comprises the fourth line segment corresponding to the second object, and the instructions that are stored in memory 880 also comprise: a second deleting unit, used in the detection unit prior to detecting obstacles including dynamic obstacles or static obstacles from the target objects, to acquire the tilt angle of the third line segment and the tilt angle of the fourth line segment; and delete the second object from the target objects if the difference between the tilt angle of the third line segment and the tilt angle of the fourth line segment is greater than the angle threshold.

Optionally, when dynamic obstacles or static obstacles are detected from the target objects based on the matching results, the detection unit is configured to: detect the third object as a static obstacle if the matching results indicate that the predicted position of the third object at the second moment matches the scanned position of the third object at the second moment; or detect the fourth object as a dynamic obstacle if the matching results indicate that the predicted position of the fourth object at the second moment matches the scanned position of the fourth object at the second moment.

Optionally, the instructions that are stored in memory 880 also comprise: a revision unit, configured to acquire a priori map information for the region of the target object's position, with the a priori map information comprising background obstacle positions; and revise the detected dynamic obstacles or static obstacles based on the background obstacle positions.

Optionally, the instructions that are stored in memory 880 also comprise: a prediction unit, used after the detection unit detects a dynamic obstacle from the target objects, to acquire the rate of travel of the dynamic obstacle from the first moment to the second moment; and predict the position of the dynamic obstacle at a third moment based on the scanned position of the dynamic obstacle at the first moment or second moment and the dynamic obstacle's rate of travel.

Optionally, the first acquisition unit is configured to conduct laser scanning of the target object at the first moment and acquire the first position. The second acquisition unit is configured to conduct laser scanning of the target object at the second moment and acquire the third position.

FIG. 9 illustrates an example transport vehicle 990 consistent with various embodiments of the present disclosure. The transport vehicle 990 comprises: a scanning device 901 and a processor 902. The processor 902 is connected to the scanning device 901.

The scanning device 901 is configured to conduct scanning of the target object at the first moment and acquire a first position, and to conduct scanning of the target object at the second moment and acquire a third position; the first position is the scanned position of the target object at the first moment, and the third position is the scanned position of the target object at the second moment.

The processor 902 is configured to predict a second position based on the first position, with the second position being the predicted position of the target object at the second moment; and to conduct matching of the second position and the third position, acquire matching results, and detect one or more dynamic obstacles or static obstacles from the target objects based on the matching results.

In some embodiments, the transport vehicle 990 can be a robot, wheelchair, hoverboard, etc. The scanning device 901 refers to a device with scanning capability, such as a laser device that emit beams such as laser. The processor 902 could be a CPU or ASIC (Application Specific Integrated Circuit), or it could be one or multiple integrated circuits configured to implement the embodiments of the present disclosure.

The different functional units of the transport vehicle provided by the present embodiment can be based on the functions and implementations of the method embodiment shown in FIG. 1 and the device embodiment shown in FIG. 8.

Those skilled in the art can clearly understand that, for the sake of a convenient and concise description, the corresponding processes in the foregoing method embodiments can be referenced for the operating processes of the systems, devices, and units of the description above.

In the embodiments of the present disclosure, it should be understood that the disclosed systems, devices, and methods can be realized in other ways. For example, the device embodiments described above are merely illustrative. For example, the partitioning of units is merely one type of logical functional partitioning. During actual implementation, they can be partitioned in other ways. For example, multiple units or components can be combined or integrated into another system, or some characteristics can be omitted or not executed. Additionally, the inter-couplings, direct couplings, or communication connections indicated or discussed can be indirect couplings or communication connects achieved through certain interfaces, devices, or units, and they can be electrical, mechanical, or another form.

The units explained as separate parts may or may not be physically separated, and parts displayed as units may or may not be physical units, e.g., they can be located in one location, or they can be distributed among multiple networked units. Some or all of the units may be selected to realize the goals of the embodiment scheme, based on actual needs.

In addition, each functional unit of every embodiment of the present disclosure can be integrated into one processing unit, or every unit can be physically independent. Also, two or more units can be integrated into one unit. These integrated units can be achieved through the use of hardware, and they can also be achieved through the use of software functional units.

If the integrated units are achieved in the form of software functional units and are sold or used as independent products, they can be stored in a computer-readable storage medium. On the basis of this understanding, the essence of the present application's technical schemes, or the parts contributing to prior art, or some or all of these technical schemes can be embodied in software product form. This computer software product is stored in a storage medium and includes a number of commands to cause a computer device (it can be a personal computer, server, or network device) to execute some or all of the steps of the methods of every embodiment of the present application. The storage medium mentioned above includes: various media capable of storing program code, such as U disks, external hard drives, read-only memory (ROM), random access memory (RAM), disks, or optical disks.

The foregoing descriptions and embodiments are only used to explain the technical schemes of the present application, and not limit them. Though a detailed description of the present application has been given referencing the foregoing embodiments, those possessing ordinary skill in the art should understand that modifications may still be made to the technical schemes recorded in the foregoing embodiments, or equivalent substitutions may be made to some technical features therein. These modifications or substitutions do not cause the essence of the corresponding technical schemes to deviate from the spirit and scope of the technical schemes of the disclosed embodiments.

1. An obstacle detection method, comprising:
acquiring a first position, wherein the first position is a scanned position of a target object at a first moment;
predicting a second position based on the first position, wherein the second position is a predicted position of the target object at a second moment;
acquiring a third position, wherein the third position is a scanned position of the target object at the second moment; and
matching the second position and the third position to obtain a matching result, and detecting one or more dynamic or static obstacles from the target object based on the matching result.

2. The method according to claim 1, wherein:
acquiring the first position comprises acquiring a position of the target object's first scan point array at the first moment, and based on the first scan point array's position, converting the first scan point array into a first line segment set, the first line segment set position indicating the first position; and
acquiring the third position comprises acquiring a position of the target object's second scan point array at the second moment, and based on the second scan point array's position, converting the second scan point array into a second line segment set, the second line segment set position indicating the third position.

3. The method according to claim 2, wherein:
converting the first scan point array into the first line segment set comprises converting the first scan point array into the first line segment set based on a length threshold, wherein a distance between each scan point in the first scan point array and the first line segment is less than the length threshold; and
converting the second scan point array into the second line segment set comprises converting the second scan point array into the second line segment set based on a length threshold, wherein a distance between each scan point in the second scan point array and the second line segment is less than the length threshold.

4. The method according to claim 2, wherein:
the target object comprises a first object;
the first line segment set comprises a first line segment corresponding to the first object;
the second line segment set comprises a second line segment corresponding to the first object; and
prior to detecting the one or more dynamic or static obstacles from the target object, the method further comprises:
removing the first object from the target object if a point density of the first line segment's scan point array is less than a density threshold; or
deleting the first object from the target object if a point density of the second line segment's scan point array is less than the density threshold.

5. The method according to claim 2, wherein:
the target object comprises a second object;
the first line segment set comprises a third line segment corresponding to the second object;
the second line segment set comprises a fourth line segment corresponding to the second object; and
prior to detecting the one or more dynamic or static obstacles from the target object, the method further comprises:
acquiring a tilt angle of the third line segment and a tilt angle of the fourth line segment; and
removing the second object from the target object if a difference between the tilt angle of the third line segment and the tilt angle of the fourth line segment is greater than an angle threshold.

6. The method according to claim 1, wherein:
the target object comprises a third object and a fourth object; and
detecting the one or more dynamic or static obstacles from the target object based on the matching result comprises:
if the matching result indicates that the predicted position of the third object at the second moment matches the scanned position of the third object at the second moment, determining the third object as the static obstacle;
if the matching result indicates that the predicted position of the fourth object at the second moment matches the scanned position of the fourth object at the second moment, determining the fourth object as the dynamic obstacle.

7. The method according to claim 1, wherein:
the method is implentable by a movable device; and
predicting the second position based on the first position comprises: predicting the second position based on the first position and a path of movement of the movable device from the first moment to the second moment.

8. The method according to claim 1, further comprising:
acquiring priori map information for a region of the target object, the priori map information comprising background obstacle positions; and
revising the detection of the dynamic or static obstacles based on the background obstacle positions.

9. The method according to claim 8, further comprising:
generating a detection confidence level based on the matching result, wherein revising the detection of the dynamic or static obstacles based on the background obstacle positions comprises: revising the detection of the dynamic or static obstacles based on the background obstacle positions and the detection confidence level.

10. The method according to claim 1, after detecting a dynamic obstacle from the target object, the method further comprising:
acquiring a rate of travel of the dynamic obstacle from the first moment to the second moment; and
predicting the position of the dynamic obstacle at a third moment based on the scanned position of the dynamic obstacle at the first moment or second moment and the dynamic obstacle's rate of travel.

11. The method according to claim 10, wherein acquiring the rate of travel of the dynamic obstacle from the first moment to the second moment comprises:
acquiring the dynamic obstacle's scan point array position at the first moment;
acquiring the dynamic obstacle's corresponding linear slope and intercept at the first moment based on the dynamic obstacle's scan point array position at the first moment;
acquiring the dynamic obstacle's scan point array position at the second moment;
acquiring the dynamic obstacle's corresponding linear slope and intercept at the second moment based on the dynamic obstacle's scan point array position at the second moment; and
acquiring the dynamic obstacle's rate of travel from the first moment to the second moment based on the dynamic obstacle's corresponding linear slopes and intercepts at the first moment and the second moment.

12. The method according to claim 10, wherein predicting the position of the dynamic obstacle at the third moment based on the scanned position of the dynamic obstacle at the first moment or second moment and the dynamic obstacle's rate of travel comprises:
acquiring the dynamic obstacle's displacement per unit time based on the dynamic obstacle's rate of travel; and
predicting the dynamic obstacle's position after at least one unit time based on the dynamic obstacle's first moment or second moment scanned position and the dynamic obstacle's displacement per unit time.

13. The method according to claim 1, wherein:
acquiring the first position is acquired comprises conducting laser scanning of the target object at the first moment to acquire the first position; and
acquiring the third position comprises conducting laser scanning of the target object at the second moment to acquire the third position.

14. A non-transitory computer-readable storage medium storing instructions that, when executed by a system, cause the system to perform a method for obstable detection, the method comprising:
acquiring a first position, wherein the first position is a scanned position of a target object at a first moment;
predicting a second position based on the first position, wherein the second position is a predicted position of the target object at a second moment;
acquiring a third position, wherein the third position is a scanned position of the target object at the second moment; and
matching the second position and the third position to obtain a matching result, and detecting one or more dynamic or static obstacles from the target object based on the matching result.

15. The non-transitory computer-readable storage medium according to claim 14, wherein:
acquiring the first position comprises acquiring a position of the target object's first scan point array at the first moment, and based on the first scan point array's position, converting the first scan point array into a first line segment set, the first line segment set position indicating the first position; and
acquiring the third position comprises acquiring a position of the target object's second scan point array at the second moment, and based on the second scan point array's position, converting the second scan point array into a second line segment set, the second line segment set position indicating the third position.

16. The non-transitory computer-readable storage medium according to claim 15, wherein:
converting the first scan point array into the first line segment set comprises converting the first scan point array into the first line segment set based on a length threshold, wherein a distance between each scan point in the first scan point array and the first line segment is less than the length threshold; and
converting the second scan point array into the second line segment set comprises converting the second scan point array into the second line segment set based on a length threshold, wherein a distance between each scan point in the second scan point array and the second line segment is less than the length threshold.

17. The non-transitory computer-readable storage medium according to claim 15, wherein:
the target object comprises a first object;
the first line segment set comprises a first line segment corresponding to the first object;
the second line segment set comprises a second line segment corresponding to the first object; and
prior to detecting the one or more dynamic or static obstacles from the target object, the method further comprises:
removing the first object from the target object if a point density of the first line segment's scan point array is less than a density threshold; or
deleting the first object from the target object if a point density of the second line segment's scan point array is less than the density threshold.

18. The non-transitory computer-readable storage medium according to claim 15, wherein:
the target object comprises a second object;
the first line segment set comprises a third line segment corresponding to the second object;
the second line segment set comprises a fourth line segment corresponding to the second object; and
prior to detecting the one or more dynamic or static obstacles from the target object, the method further comprises:
acquiring a tilt angle of the third line segment and a tilt angle of the fourth line segment; and
removing the second object from the target object if a difference between the tilt angle of the third line segment and the tilt angle of the fourth line segment is greater than an angle threshold.

19. The non-transitory computer-readable storage medium according to claim 14, wherein:
the target object comprises a third object and a fourth object; and
detecting the one or more dynamic or static obstacles from the target object based on the matching result comprises:
if the matching result indicates that the predicted position of the third object at the second moment matches the scanned position of the third object at the second moment, determining the third object as the static obstacle;
if the matching result indicates that the predicted position of the fourth object at the second moment matches the scanned position of the fourth object at the second moment, determining the fourth object as the dynamic obstacle

20. The non-transitory computer-readable storage medium according to claim 14, wherein the method further comprises:
acquiring priori map information for a region of the target object, the priori map information comprising background obstacle positions; and
revising the detection of the dynamic or static obstacles based on the background obstacle positions.

21. The non-transitory computer-readable storage medium according to claim 14, wherein after detecting a dynamic obstacle from the target object, the method further comprising:
acquiring a rate of travel of the dynamic obstacle from the first moment to the second moment; and
predicting the position of the dynamic obstacle at a third moment based on the scanned position of the dynamic obstacle at the first moment or second moment and the dynamic obstacle's rate of travel.

22. The non-transitory computer-readable storage medium according to claim 14, wherein:
acquiring the first position is acquired comprises conducting laser scanning of the target object at the first moment to acquire the first position; and
acquiring the third position comprises conducting laser scanning of the target object at the second moment to acquire the third position.

23. A transport vehicle, comprising:
a scanning device configured to conduct scanning of a target object at a first moment to acquire a first position, and to conduct scanning of the target object at a second moment to acquire a third position, wherein the first position is a scanned position of the target object at the first moment, and the third position is a scanned position of the target object at the second moment; and
a processor configured to predict a second position of the target object at the second moment based on the first position, and to match the second position and the third position to obtain a matching result, and detect one or more dynamic or static obstacles from the target object based on the matching result.
